(19) United States
(12) Patent Application Publication
(10) Pub. No.: US 2017/0191336 A1
(43) Pub. Date: Jul. 6, 2017

(54) CLOSURE MEMBER INCLUDING A REPLACEABLE INSERT

(71) Applicant: CAMERON INTERNATIONAL CORPORATION, Houston, TX (US)

(72) Inventors: Melvyn F. WHITBY, Houston, TX (US); Matthew GIVENS, Houston, TX (US)

(73) Assignee: CAMERON INTERNATIONAL CORPORATION, Houston, TX (US)

(21) Appl. No.: 15/394,067

(22) Filed: Dec. 29, 2016

Related U.S. Application Data
(60) Provisional application No. 62/273,787, filed on Dec. 31, 2015.

(51) Int. Cl. E21B 33/06; B23P 15/00; B23P 6/00

(52) U.S. Cl. CPC E21B 33/062; B23P 6/00; B23P 15/001; E21B 33/064

(57) ABSTRACT

A blowout preventer includes a body including a first end, a second end spaced from the first end, and a first lateral end extending between the first end and the second end, wherein the body includes a throughbore extending between the first end and the second end, and a first passageway extending between the first lateral end and the throughbore, and a removeable insert disposed in the first passageway, and wherein the removeable insert includes a throughbore for receiving a ram block of the blowout preventer.

### CROSS-REFERENCE TO RELATED APPLICATIONS

This application claims benefit of U.S. provisional patent application Ser. No. 62/273,787 filed Dec. 31, 2015, and entitled “Closure Member Including A Replaceable Insert,” which is hereby incorporated herein by reference in its entirety.

### STATEMENT REGARDING FEDERALLY SPONSORED RESEARCH OR DEVELOPMENT

Not applicable.

### BACKGROUND

Hydrocarbon drilling systems utilize drilling fluid or mud for drilling a wellbore in a subterranean earthen formation. Drilling systems often utilize a blowout preventer (BOP) stack or system to seal, control, and monitor the wellbore to prevent an uncontrolled release of wellbore fluids to the surrounding environment, such as in the event of an uncontrolled influx of fluid from the formation into the wellbore. BOP stacks may comprise one or more actuatable valves or mechanical devices, such as ram and annular BOPs. In offshore applications, the BOP stack may further include electrical and hydraulic lines, control pods, hydraulic accumulators, kill and choke lines and valves, and a support frame. Ram BOPs of the BOP stack typically comprise a pair of opposed rams that are actuated rectilinearly towards a central throughbore or chamber of the ram BOP, where the rams of the ram BOP may comprise, among others, pipe rams for closing around a drill pipe extending through the central throughbore, shear rams for shearing a drill pipe extending through the central throughbore, and blind shear rams for both shearing the drill pipe and sealing the wellbore. In some applications, the individual ram BOPs of a BOP stack may be periodically actuated to confirm their operational readiness. Each actuation of the ram BOP results in normal operational wear on the sealing surfaces therein. Further, during each actuation, cuttings and other debris suspended in the fluid disposed in the ram BOP may be carried by the individual rams, possibly scoring or damaging the sealing surfaces of the ram BOP. In response to normal wear and damage occurring to these sealing surfaces, the ram BOP may need to be refurbished via a heat treating process, where the ram BOP may only be refurbished a finite number of times prior to retirement. Further, in some applications, the outer surface of the drill pipe extending through the ram BOP may inadvertently engage an inner surface of the ram BOP, possibly scoring or damaging the inner surface.

### SUMMARY

An embodiment of a blowout preventer comprises a body comprising a first end, a second end spaced from the first end, and a first lateral end extending between the first end and the second end, wherein the body comprises a throughbore extending between the first end and the second end, and a first passageway extending between the first lateral end and the throughbore, and a removeable insert disposed in the first passageway, and wherein the removeable insert comprises a throughbore for receiving a ram block of the blowout preventer. In some embodiments, an outer surface of the ram block slidably engages an inner surface of the removeable liner. In some embodiments, an inner surface of the removeable insert comprises a liner. In certain embodiments, the liner comprises a harder material than the material comprising the body. In certain embodiments, the removeable insert comprises a harder material than the material comprising the body. In some embodiments, the removeable insert is fitted within the first passageway of the body using an interference fit. In some embodiments, the body comprises a second lateral end spaced from the first lateral end, wherein the second lateral end extends between the first end and the second end of the body, the body comprises a second passageway extending between the second lateral end and the throughbore of the body, and the removeable insert is disposed in the second passageway and extends from the first lateral end to the second lateral end of the body. In certain embodiments, the blowout preventer further comprises a first throughbore insert extending into the throughbore from the first end of the body, and a second throughbore insert extending into the throughbore from the second end of the body, wherein an inner surface defining the throughbore of the body comprises an inner surface of the first throughbore and an inner surface of the second throughbore.

An embodiment of a blowout preventer comprises a body comprising a first end, a second end spaced from the first end, a first lateral end and a second lateral end spaced from the first lateral end and wherein each of the first and second lateral ends extends between the first end and the second end, a throughbore extending between the first end and the second end, a first passageway extending between the first lateral end and the throughbore, and a second passageway extending between the second lateral end and the throughbore, and a removeable insert disposed in the first passageway and the second passageway, wherein the removeable insert extends from the first lateral end to the second lateral end. In some embodiments, the removeable insert comprises a throughbore for receiving a ram block of the blowout preventer. In some embodiments, an outer surface of the ram block slidably engages an inner surface of the removeable insert. In certain embodiments, the removeable insert comprises a first aperture extending through an outer surface of the removeable insert, and a second aperture extending through the outer surface of the removeable insert. In certain embodiments, the first aperture and the second aperture are each aligned with the throughbore of the body. In some embodiments, the blowout preventer further comprises a bonnet coupled to the first lateral end of the body. In certain embodiments, the blowout preventer further comprises a first throughbore insert extending into the throughbore from the first end of the body, and a second throughbore insert extending into the throughbore from the second end of the body, wherein an inner surface defining the throughbore of the body comprises an inner surface of the first throughbore and an inner surface of the second throughbore. In some embodiments, the first throughbore insert and the second throughbore insert each comprise a material that is harder than the material comprising the body.

An embodiment of a method of repairing a blowout preventer comprises inserting a first insert into a passageway of the blowout preventer, displacing a ram block of the blowout preventer through a throughbore of the first insert, and removing the first insert from the passageway of the blowout preventer. In some embodiments, the method further comprises heating a body of the blowout preventer and cooling the first insert prior to inserting the insert into the passageway of the blowout preventer. In some embodiments, the method further comprises repairing an inner surface of the first insert. In certain embodiments, the method further comprises inserting a second insert into the passageway of the blowout preventer.

### BRIEF DESCRIPTION OF THE DRAWINGS

For a detailed description of exemplary embodiments, reference will now be made to the accompanying drawings in which:

FIG. 1 is a schematic view of an embodiment of a drilling system including an embodiment of a BOP assembly in accordance with principles disclosed herein;

FIG. 2 is a cross-sectional perspective view of an embodiment of a ram BOP of the BOP assembly of FIG. 1 in accordance with principles disclosed herein;

FIG. 3 is a side view of an embodiment of a BOP body of the ram BOP of FIG. 2 in accordance with principles disclosed herein;

FIG. 4 is a cross-sectional view along lines 4-4 of the BOP body of FIG. 3;

FIG. 5 is a cross-sectional perspective view of another embodiment of a ram BOP of the BOP assembly of FIG. 1 in accordance with principles disclosed herein

FIG. 6 is a side view of an embodiment of a BOP body of the ram BOP of FIG. 5 in accordance with principles disclosed herein; and

FIG. 7 is a cross-sectional view along lines 7-7 of the BOP body of FIG. 6.

### DETAILED DESCRIPTION

In the drawings and description that follow, like parts are typically marked throughout the specification and drawings with the same reference numerals. The drawing figures are not necessarily to scale. Certain features of the disclosed embodiments may be shown exaggerated in scale or in somewhat schematic form and some details of conventional elements may not be shown in the interest of clarity and conciseness. The present disclosure is susceptible to embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed below may be employed separately or in any suitable combination to produce desired results.

Unless otherwise specified, in the following discussion and in the claims, the terms “including” and “comprising” are used in an open-ended fashion, and thus should be interpreted to mean “including, but not limited to . . . ”. Any use of any form of the terms “connect”, “engage”, “couple”, “attach”, or any other term describing an interaction between elements is not meant to limit the interaction to direct interaction between the elements and may also include indirect interaction between the elements described. The various characteristics mentioned above, as well as other features and characteristics described in more detail below, will be readily apparent to those skilled in the art upon reading the following detailed description of the embodiments, and by referring to the accompanying drawings.

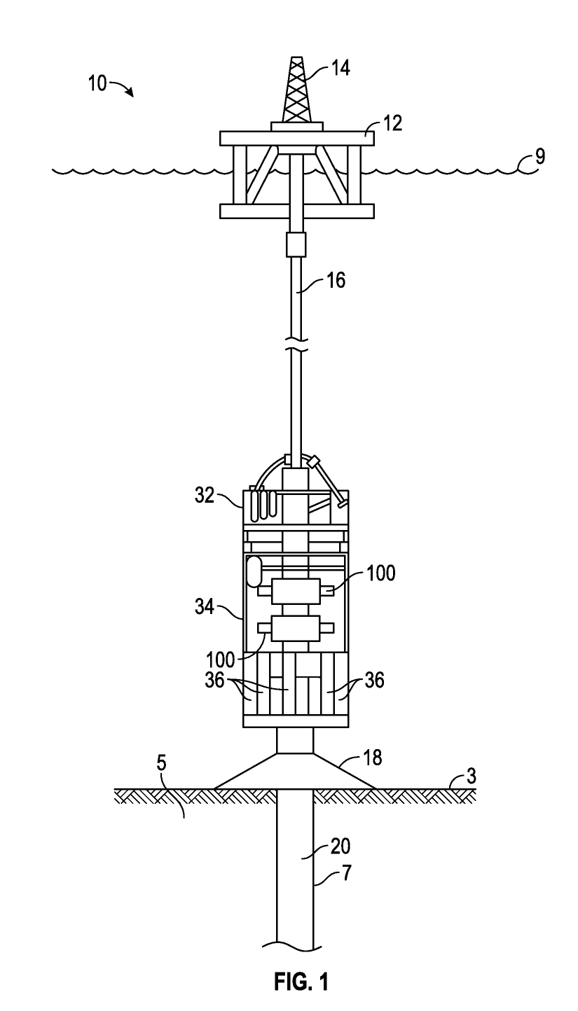

FIG. 1 is a schematic diagram illustrating an embodiment of a drilling system 10. The drilling system 10 can be configured to extract various minerals and natural resources, including hydrocarbons (e.g., oil and/or natural gas), or configured to inject substances into a sea floor 3 and a subterranean earthen formation 5 via a well or wellbore 7. In this embodiment, drilling system 10 generally includes a drilling vessel 12 disposed at a surface or waterline 9, a wellhead 18 secured to the sea floor 3 via a casing conductor 20 that extends into the formation 5, a marine riser 16 extending towards the sea floor 3 from the drilling vessel 12, and a blowout preventer (BOP) assembly 30 disposed beneath the waterline 9 and connected to a lower end of the riser 16. In this embodiment, vessel 12 is a floating platform, and thus, may also be referred to as platform 12, and includes a drilling derrick 14. In other embodiments, the vessel (e.g., vessel 12) can be a drill ship or any other vessel disposed at the sea surface for conducting offshore drilling and/or production operations.

In this embodiment, BOP assembly 30 includes a pair of closure devices or ram BOPs 100 coupled to the upper end of wellhead 18 and a lower marine riser package (LMRP) 32 connected to the lower end of marine riser 16. During drilling operations, riser 16 takes drilling/formation fluid returns to platform 12. Further, riser 16 is coupled to electrical and hydraulic lines (not shown) for powering and controlling the actuation of components of BOP assembly 30, including ram BOPs 100. BOP assembly 30 is generally configured to provide emergency pressure control of drilling/formation fluid in the wellbore 7 should a sudden pressure surge escape the formation 5 into the wellbore 7. BOP assembly 30 may thereby prevent damage to the drilling vessel 12 and the marine riser 16 from fluid pressure exiting wellhead 18. In this embodiment, BOP assembly 30 also includes a frame 34 for physically supporting components of BOP assembly 30, including ram BOPs 100, and a plurality of accumulators 36 configured to provide backup hydraulic fluid pressure for actuating components of BOP assembly 30, such as ram BOPs 100. Although ram BOPs 100 are shown in FIG. 1 as forming a part of offshore drilling system 10, in other embodiments, ram BOPs 100 may be utilized in other applications, such as conventional, land based drilling systems.

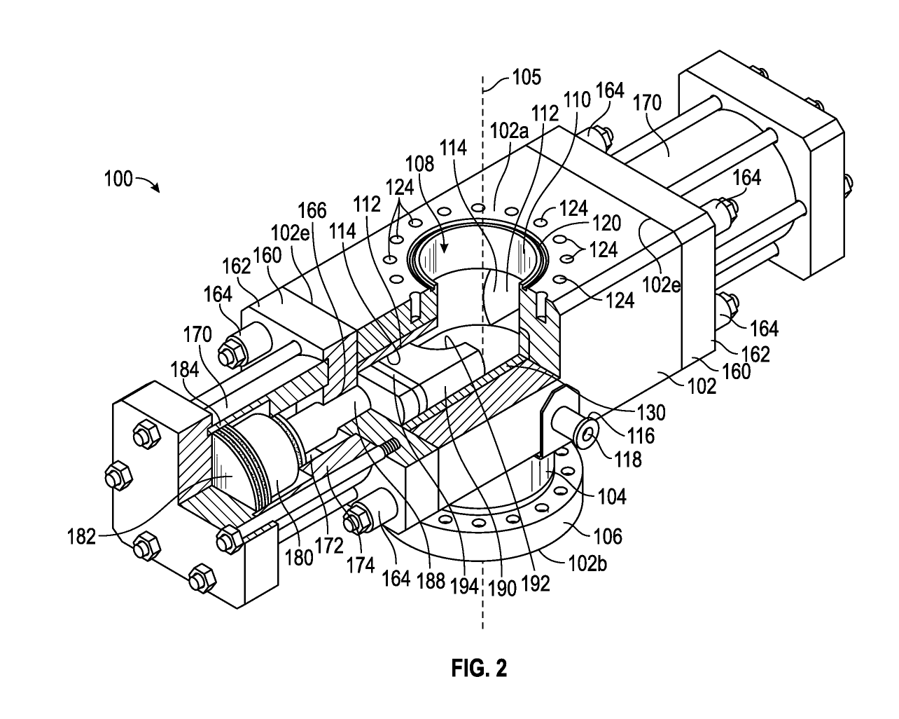

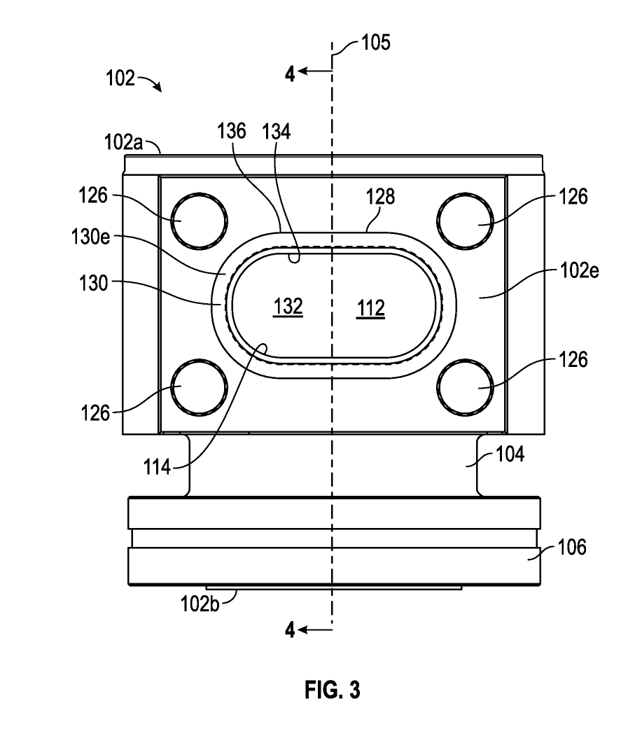

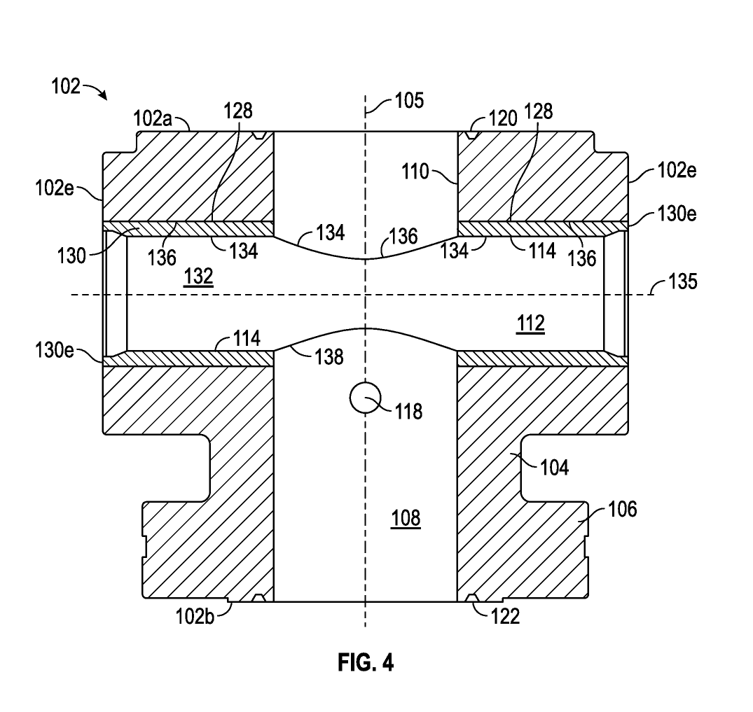

Referring to FIGS. 2-4, in this embodiment the ram BOP 100 of BOP stack 11 has a central or longitudinal axis 105 and generally includes a BOP body or housing 102, bonnets 160, and ram assemblies 180. In this embodiment, ram BOP 100 comprises a pipe ram BOP configured to seal about the outer surface of a tubular member extending through ram BOP 100; however, in other embodiments, ram BOP 100 may comprise other types of ram BOPs known in the art, such as shear or blind ram BOPs. Body 102 includes a first or upper end 102a, a second or lower end 102b, and a pair of lateral ends 102e that engage bonnets 160. In this embodiment, body 102 is generally rectangular in shape and includes a conduit 104 extending therefrom, wherein conduit 104 includes a flange or connector 106 at lower end 102b. Body 102 includes a central throughbore 108 extending between upper end 102a and lower end 102b, where throughbore 108 is disposed coaxially with longitudinal axis 105 and is defined by a generally cylindrical inner surface 110.

Body 102 also includes a pair of laterally extending ram passageways 112. In this embodiment, each ram passageway 112 extends laterally (i.e., normal to longitudinal axis 105) between throughbore 108 and a lateral end 102e of body 102, and is defined by an inner surface 114 having a generally oval shaped cross-section. In this configuration, each ram passageway 112 is in selective fluid communication with throughbore 108. However, as will be explained further herein, in this embodiment a closure member of each ram assembly 180 is configured to seal at least a portion of ram passageway 112. In this embodiment, body 102 further includes a lateral inlet 116 including an internal passageway 118 that extends between throughbore 108 and the surrounding environment, where inlet 116 is circumferentially offset from ram passageways 112 respective longitudinal axis 105.

In this embodiment body 102 includes a first or upper annular groove 120 extending into the outer surface of body 102 at upper end 102a, and a second or lower annular groove 122 extending into the outer surface of body 102 at lower end 102b, where both upper groove 120 and lower groove 122 are each disposed coaxially with longitudinal axis 105. Body 102 also includes a first or upper set of circumferentially spaced apertures 124 extending into upper end 102a and a second or lower plurality of circumferentially spaced apertures 126 extending into lower end 102b, where both upper apertures 124 and lower apertures 126 are each disposed coaxially with longitudinal axis 105. Further, upper apertures 124 and lower apertures 126 are both disposed radially outwards respective corresponding upper groove 120 and lower groove 122, respectively. In this manner, releasable fasteners may be threadably inserted into upper apertures 124 and lower apertures 126 to releasably couple ram BOP 100 to other components of BOP assembly 30.

Each bonnet 160 of ram BOP 100 is configured to releasably couple with body 102 and house at least a portion of a corresponding ram assembly 180. In this embodiment, each bonnet 160 generally includes a mounting plate 162 and a cylinder 170 coupled to and extending laterally from mounting plate 162. Each bonnet 160 is releasably secured to body 102 via a plurality of spaced fasteners 164 that extend through mounting plate 162 and into a lateral end 102e of body 102. Particularly, each lateral end 102e of body 102 includes a plurality of apertures 126 circumferentially spaced about the corresponding ram passageway 112 for threadably receiving and coupling with fasteners 164 of bonnet 160. The mounting plate 162 of each bonnet 160 also includes a centrally disposed bore 166 extending therethrough. The cylinder 170 of each bonnet 160 includes a centrally disposed bore 172 defined by a generally cylindrical inner surface 174.

The ram assembly 180 of each bonnet 160 is configured to actuate ram BOP 100 between an open position (shown in FIG. 2) where fluid flow is permitted through throughbore 108, and a closed position where fluid flow is restricted through throughbore 108. In this embodiment, each ram assembly 180 generally includes a piston 182, a connecting rod 188, and a seal member or ram block 190. Piston 182 is slidably disposed within cylinder 170 and includes an annular seal for sealingly engaging the inner surface 174 of cylinder 170. The connecting rod 188 is connected to an inner longitudinal end of piston 182 and extends through bore 166 in mounting plate 162 to connect to an inner longitudinal end of ram block 190, thereby coupling piston 184 with ram block 190.

The ram block 190 of each ram assembly 180 has an inner sealing surface 192 for sealing against the outer surface of a tubular member extending through throughbore 108. Although in this embodiment ram block 190 comprises a pipe ram for sealing against a drill pipe, in other embodiments, ram block 190 may comprise a blind, shear, or blind shear ram, as well as other types known in the art. In this embodiment, each ram block 190 also includes an annular seal 194 disposed on an outer surface of ram block 190 for sealing against the inner surface 114 of a corresponding ram passageway 112. In this manner, the bore 172 of each cylinder 170 is sealed from throughbore 108 of body 102. Each ram assembly 180 may be actuated from a radially outer position (shown in FIG. 2) corresponding with the open position of ram BOP 100 to a radially inner position corresponding with the closed position of ram BOP 100 by displacing fluid into bore 172 of cylinder 170 via a first port (not shown) so as to pressurize the radially outer end of piston 182, thereby displacing piston 182 and the ram block 190 coupled thereto towards longitudinal axis 105 of ram BOP 100. Similarly, each ram assembly 180 may be actuated from the radially inner position to the radially outer position by displacing fluid into bore 172 of cylinder 170 via a second port (not shown) so as to pressurize the radially inner end of piston 182, thereby displacing piston 182 and the ram block 190 coupled thereto orthogonally away from longitudinal axis 105 of ram BOP 100.

When ram BOP 100 is actuated between the open position (shown in FIG. 2) and the closed position, the seal 194 of each ram block 190 slidingly engages the inner surface 114 of a corresponding ram passageway 112 to seal thereagainst. As ram BOP 100 is continually actuated over the course of its service life, cuttings and other debris entrained in the drilling or wellbore fluid passing through throughbore 108 may incidentally engage the inner surface 114 of each ram passageway, thereby scoring inner surface 114 and degrading the quality of the seal formed between annular seal 194 and inner surface 114. Moreover, normal wear and tear over the operational life of ram BOP 100 also degrades the quality of the seal formed between annular seal 194 and inner surface 114. Eventually, as surface 114 is continually degraded with repeated actuations of ram BOP 100, annular seal 194 of each ram block 190 will no longer be capable of adequately sealing against inner 114, necessitating the removal of ram BOP 100 from drilling system 10 and either the replacement or repairmen of inner surface 114. In some applications, repairing body 102 of ram BOP 100 following sufficient degradation of inner surface 114 may comprise performing a heat treatment of body 102. In some applications, body 102 may only be heat treated for a predetermined number of cycles before body 102 is replaced, either due to applicable regulations or degradation of the material comprising body 102. Thus, repeated scoring or other damage to inner surface 114 may result in eventual replacement of BOP body 102.

In this embodiment, body 102 of ram BOP 100 includes a ram passageway insert member 130 disposed therein. As will be discussed further herein, an inner surface of passageway insert 130 is configured to comprise the inner surface 114 of ram passageway 112 such that passageway insert 130 may be removed and replaced or repaired following sufficient degradation of inner surface 112. In this manner, body 102 of ram BOP 100 may be provided with a repaired or new passageway insert 130, allowing body 102 to be reused in ram BOP 100. Further, the removability of passageway insert 130 allows for inner surface 114 to be replaced or repaired without subjecting body 102 to a heat treatment that may eventually damage body 102 or otherwise render body 102 unfit for operational service, thereby extending the service life of body 102.

Passageway insert 130 of body 102 is generally tubular in shape and has a central or longitudinal axis 135, a pair of lateral ends 130e, a throughbore 132 defined by an inner surface 134, and an outer surface 136. When assembled with body 102, the longitudinal axis 135 of passageway insert 130 is disposed coaxially with ram passageways 112 and bonnets 160. In this embodiment, passageway insert 130 has a generally oval shaped cross-section corresponding to the cross-section of the ram passageways 112 of body 102; however, in other embodiments, passageway insert 130 may include cross-sections comprising other shapes. In this arrangement, throughbore 132 of passageway insert 130 comprises or forms both ram passageways 112 of body 102 while the inner surface 134 of passageway insert 130 comprises or forms the inner surface 114 of each ram passageway 112. Also, in this embodiment, each lateral end 130e of passageway insert 130 is disposed substantially flush with a corresponding lateral end 102e of body 102; however, in other embodiments, the lateral ends 130e of passageway insert 130 may not sit substantially flush with lateral ends 102e of body 102.

Passageway insert 130 of body 102 includes a first or upper aperture 136 and a second or lower aperture 138, where each aperture 136 and 138 extends radially through passageway insert 130 relative longitudinal axis 135. Thus, upper aperture 136 and lower aperture 138 are configured to allow for the passage of fluid through throughbore 108 of body 102 via passing radially through throughbore 132 and apertures 134 and 136 of passageway insert 130 (relative longitudinal axis 135) when ram BOP 100 is in the open position. In this arrangement, apertures 134 and 136 each angularly align with throughbore 108 of body 102. Particularly, in this embodiment, both upper aperture 134 and lower aperture 136 include a diameter substantially equal to the diameter of throughbore 108 of body 102; however, in other embodiments, the diameter of apertures 134 and 136 may vary from the diameter of throughbore 108. Also in this arrangement, internal passageway 118 of body 102 is longitudinally offset (relative longitudinal axis 105) from passageway insert 130, thereby allowing for fluid communication between internal passageway 118 and throughbore 108.

In this embodiment, passageway insert 130 comprises steel, such as a high alloy steel, similar to the material comprising body 102. Also in this embodiment, inner surface 134 of passageway insert 130 comprises a liner 136. In certain embodiments, liner 136 comprises a superalloy, such as Inconel, or other high hardness materials known in the art. Thus, in this embodiment, liner 136 comprises a material having a higher hardness than the material comprising passageway insert 130 or the material comprising body 102. Although in this embodiment passageway insert 130 comprises a liner 136 on inner surface 134, in other embodiments, inner surface 134 of passageway insert 130 may not include a liner. Further, in certain embodiments, passageway insert 130 comprises a superalloy, such as Inconel, or other high hardness materials known in the art. Thus, in this embodiment, the material comprising passageway insert 130 has a higher hardness than the material comprising body 102.

In this embodiment, the coupling between passageway insert 130 and body 102 comprises an interference fit. Particularly, frictional engagement between the outer surface 134 of passageway insert 130 and an inner passageway surface 128 of body 102 frictionally couples passageway insert 130 with body 102 such that relative angular or axial movement between passageway insert 130 and body 102 is restricted. In certain embodiments, an annular seal (not shown) is disposed radially between the outer surface 134 of passageway insert 130 and the inner passageway surface 128 of body 102 at each lateral end 102e of body 102, where each annular seal would provide sealing engagement between outer surface 134 and inner passageway surface 128.

In certain embodiments, the interference fit between passageway insert 130 and body 102 comprises a shrink fit. Particularly, body 102 may be heated to a temperature below the annealing temperature of the material comprising body 102, causing body 102 to expand, while passageway insert 130 is cooled (e.g., via liquid nitrogen or other fluid), causing passageway insert 130 to be reduced in size. Once body 102 has been allowed to expand and passageway insert 130 has been allowed to cool, passageway insert 130 is inserted into the ram passageways 114 of body 102 until the lateral ends 130e of passageway insert 130 are aligned with the lateral ends 102e of body 102, as shown in FIGS. 2-4.

As body 102 cools and passageway insert 130 warms, outer surface 136 of passageway insert 130 will frictionally engage the inner passageway surface 128 of body 128. The body 102 may be again heated while passageway insert 130 is cooled to allow for the removal of passageway insert 130 from body 102 when it becomes necessary to either repair or replace passageway insert 130 due to the degradation of inner surface 134, or for other reasons. In other embodiments, the interference fit between body 102 and passageway insert 130 comprises a press or friction fit. In this embodiment, mechanical or hydraulic force is utilized to forcibly insert passageway insert 130 into the ram passageways 112 of body 102. In still further embodiments, passageway insert 130 may be secured to body 102 through other mechanisms besides an interference fit, such as bonding the outer surface 136 of passageway insert 130 to the inner passageway surface 128 of body 102 using an adhesive or other bonding agent.

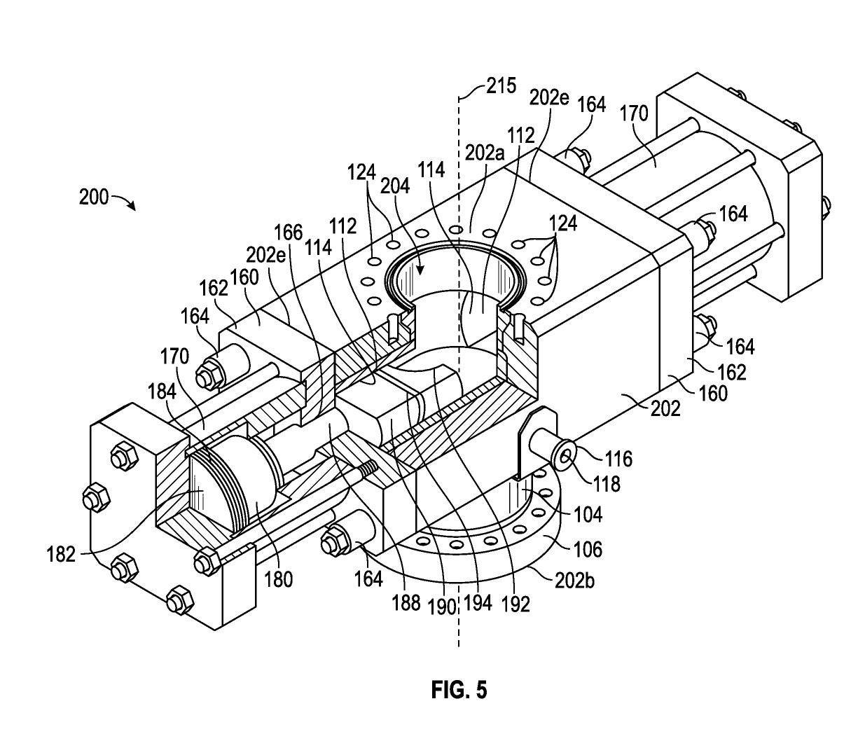

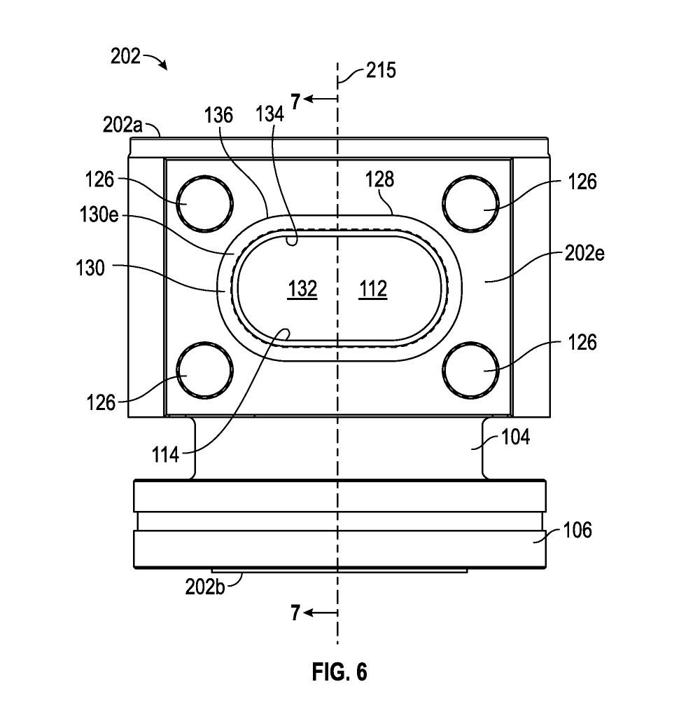

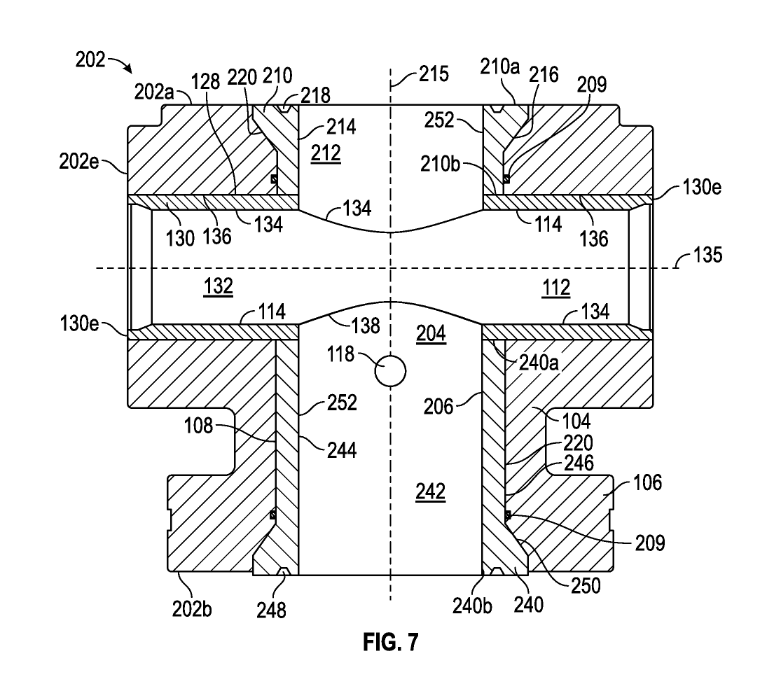

Referring to FIGS. 5-7, another embodiment of a ram BOP 200 is shown. Ram BOP 200 shares similar features with ram BOP 100 shown in FIGS. 2-4, and shared features have been labeled similarly. Also, ram BOP 200 may be utilized with drilling system 10 in lieu of ram BOP 100. In this embodiment, ram BOP 200 generally includes a BOP body 202 and a pair of bonnets 160, where each bonnet 160 includes an actuation assembly 180, similar to the arrangement of ram BOP 100. In this embodiment, body 202 has a central or longitudinal axis 215, a first or upper end 202a, a second or lower end 202b, and a pair of lateral ends 202e. Body 202 also includes a central throughbore 204 extending between upper end 202a and lower end 202b, where throughbore 204 is defined by a generally cylindrical inner surface 206.

Body 202 of ram BOP 200 shares many features with body 102 of ram BOP 100, including passageway insert 130. However, body 202 further includes a first or upper throughbore insert 210 and a second or lower throughbore insert 240. Particularly, upper throughbore insert 210 has a first or upper end 210a, a second or lower end 210b, a central throughbore 212 extending between upper end 210a and 210b and defined by a generally cylindrical inner surface 214, and a generally cylindrical outer surface 216. Upper throughbore insert 210 also includes an annular seal groove 218 extending into upper end 210a, and outer surface 216 includes a downward facing (i.e., facing lower end 210b) conical section 220. Similarly, lower throughbore insert 240 includes a first or upper end 240a, a second or lower end 240b, a central throughbore 242 extending between upper end 240a and 240b and defined by a generally cylindrical inner surface 244, and a generally cylindrical outer surface 246. Lower throughbore insert 240 also includes an annular seal groove 248 extending into lower end 240a, and outer surface 246 includes an upward facing (i.e., facing upper end 240a) conical section 250. In this arrangement, annular seals can be received in annular groove 218 of upper insert 210 and annular groove 248 of lower insert 240 to seal against components coupled with body 202.

During operation of ram BOP 200, a drill pipe (not shown) extending through throughbore 204 of body 202 may bend or buckle, and due to this bending or buckling of the drill pipe, the outer surface of the drill pipe may physically contact the inner surface 206 of throughbore 204, thereby possibly scoring or otherwise damaging inner surface 206. Thus, in some applications, the inner surface 206 of throughbore 204 will need to be periodically repaired or replaced. In some applications, repairing the BOP body to treat scoring of inner surface 206 includes heat treating the BOP body, and thus, the BOP body may need to be replaced after a sufficient number of heat treatments to correct damage to inner surface 206, thereby shortening the service life of the BOP body. In the embodiment of FIGS. 5-7, the inner surface 214 of upper insert 210 and the inner surface 244 of lower insert 240 comprise or form the inner surface 204 of throughbore 206. Thus, upon damaging of inner surface 214 and/or inner surface 244, upper insert 210 and/or lower insert 240 can be removed from body 202 and repaired or replaced without exposing body 202 to a heat treat cycle, thereby extending the service life of body 202.

In this embodiment, the inner surface 214 of upper insert 210 and the inner surface 244 of lower insert 240 are each coated with or comprise a liner 252. In certain embodiments, liner 252 comprises a superalloy, such as Inconel, or other high hardness materials known in the art. Thus, in this embodiment, liner 252 comprises a material having a higher hardness than the material comprising upper insert 210, lower insert 240, and the material comprising body 202. Although in this embodiment each insert (upper insert 210 and lower insert 240) comprises a liner 252 on inner surfaces 214 and 244, respectively, in other embodiments, inner surfaces 214 and 244 may not include a liner. Further, in certain embodiments, upper insert 210 and lower insert 240 each comprises a superalloy, such as Inconel, or other high hardness materials known in the art. Thus, in this embodiment, the material comprising upper insert 210 and lower insert 240 has a higher hardness than the material comprising body 202.

In this embodiment, the coupling between upper insert 210 and lower insert 240 with body 202 comprises an interference fit. Particularly, frictional engagement between the outer surface 216 of upper insert 210 and outer surface 246 of lower insert 240 with a generally cylindrical inner throughbore surface 208 of body 202 frictionally couples upper and lower inserts 210 and 240 with body 202 such that relative angular or axial movement between upper and lower inserts 210 and 240, respectively, and body 202 is restricted. An annular seal 209 is disposed radially between the outer surface 216 and 246 of inserts 210 and 240, respectively, and the inner throughbore surface 208 to restrict fluid communication therethrough. In certain embodiments, the interference fit between upper and lower inserts 210 and 240, respectively, and body 202 comprises a shrink fit, similar to as discussed above with respect to upper insert 210 and lower insert 240. In other embodiments, upper insert 210 and lower insert 240 may be secured to body 202 through other mechanisms besides an interference fit, such as bonding the outer surfaces 216 and 246 of upper insert 210 and lower insert 240, respectively to the inner through surface 208 of body 202 using an adhesive or other bonding agent.

The above discussion is meant to be illustrative of the principles and various embodiments of the present disclosure. While certain embodiments have been shown and described, modifications thereof can be made by one skilled in the art without departing from the spirit and teachings of the disclosure. The embodiments described herein are exemplary only, and are not limiting. Accordingly, the scope of protection is not limited by the description set out above, but is only limited by the claims which follow, that scope including all equivalents of the subject matter of the claims.

What is claimed is:

1. A blowout preventer, comprising:
a body comprising a first end, a second end spaced from the first end, and a first lateral end extending between the first end and the second end, wherein the body comprises a throughbore extending between the first end and the second end, and a first passageway extending between the first lateral end and the throughbore; and
a removeable insert disposed in the first passageway, and wherein the removeable insert comprises a throughbore for receiving a ram block of the blowout preventer.

2. The blowout preventer of claim 1, wherein an outer surface of the ram block slidably engages an inner surface of the removeable liner.

3. The blowout preventer of claim 1, wherein an inner surface of the removeable insert comprises a liner.

4. The blowout preventer of claim 3, wherein the liner comprises a harder material than the material comprising the body.

5. The blowout preventer of claim 1, wherein the removeable insert comprises a harder material than the material comprising the body.

6. The blowout preventer of claim 1, wherein the removeable insert is fitted within the first passageway of the body using an interference fit.

7. The blowout preventer of claim 1, wherein:
the body comprises a second lateral end spaced from the first lateral end, wherein the second lateral end extends between the first end and the second end of the body;
the body comprises a second passageway extending between the second lateral end and the throughbore of the body; and
the removeable insert is disposed in the second passageway and extends from the first lateral end to the second lateral end of the body.

8. The blowout preventer of claim 1, further comprising:
a first throughbore insert extending into the throughbore from the first end of the body; and
a second throughbore insert extending into the throughbore from the second end of the body;
wherein an inner surface defining the throughbore of the body comprises an inner surface of the first throughbore and an inner surface of the second throughbore.

9. A blowout preventer, comprising:
a body comprising a first end, a second end spaced from the first end, a first lateral end and a second lateral end spaced from the first lateral end and wherein each of the first and second lateral ends extends between the first end and the second end, a throughbore extending between the first end and the second end, a first passageway extending between the first lateral end and the throughbore, and a second passageway extending between the second lateral end and the throughbore; and
a removeable insert disposed in the first passageway and the second passageway, wherein the removeable insert extends from the first lateral end to the second lateral end.

10. The blowout preventer of claim 9, wherein the removeable insert comprises a throughbore for receiving a ram block of the blowout preventer.

11. The blowout preventer of claim 10, wherein an outer surface of the ram block slidably engages an inner surface of the removeable insert.

12. The blowout preventer of claim 9, wherein the removeable insert comprises a first aperture extending through an outer surface of the removeable insert, and a second aperture extending through the outer surface of the removeable insert.

13. The blowout preventer of claim 12, wherein the first aperture and the second aperture are each aligned with the throughbore of the body.

14. The blowout preventer of claim 9, further comprising a bonnet coupled to the first lateral end of the body.

15. The blowout preventer of claim 9, further comprising:
a first throughbore insert extending into the throughbore from the first end of the body; and
a second throughbore insert extending into the throughbore from the second end of the body;
wherein an inner surface defining the throughbore of the body comprises an inner surface of the first throughbore and an inner surface of the second throughbore.

16. The blowout preventer of claim 15, wherein the first throughbore insert and the second throughbore insert each comprise a material that is harder than the material comprising the body.

17. A method of repairing a blowout preventer, comprising:
inserting a first insert into a passageway of the blowout preventer;
displacing a ram block of the blowout preventer through a throughbore of the first insert; and
removing the first insert from the passageway of the blowout preventer.

18. The method of claim 17, further comprising heating a body of the blowout preventer and cooling the first insert prior to inserting the insert into the passageway of the blowout preventer.

19. The method of claim 17, further comprising repairing an inner surface of the first insert.

20. The method of claim 17, further comprising inserting a second insert into the passageway of the blowout preventer.
